(19) United States
(12) Patent Application Publication
(10) Pub. No.: US 2009/0299945 A1
(43) Pub. Date: Dec. 3, 2009

(54) PROFILE MODELING FOR SHARING INDIVIDUAL USER PREFERENCES

(75) Inventor: Rick Hangartner, Corvallis, OR (US)

Correspondence Address: Stolowitz Ford Cowger LLP, 621 SW Morrison St, Suite 600, Portland, OR, 97205, US

(73) Assignee: Strands, Inc., Corvallis, OR (US)

(21) Appl. No.: 12/474,616

(22) Filed: May 29, 2009

Related U.S. Application Data
(60) Provisional application No. 61/058,517, filed on Jun. 3, 2008.

(51) Int. Cl. G06N 5/02

(52) U.S. Cl. 706/50; 706/46

(57) ABSTRACT

A computer-implemented method (FIG. 4), systems (FIG. 6) and data structures (420, 466) are disclosed for creating and exchanging a compact, machine-usable user taste profile (140,416,608). The method may include accessing an associational knowledge base “AKB” (124,406) that stores relationships among a catalog of items in computer-usable form. The AKB includes identification of a plurality of “categories” (304,306,310) wherein each category is a subset of the catalog of items (300), and the categories are defined based on similarity among the items within a category. User interactions (126,410) with an application (404) driven by an AKB (406) are analyzed relative to the categorization (412,414,416) by application of profile factors (450) to estimate a user profile (416). The user profile can be exported to other applications that are driven by a compatible AKB in order to provide an experience tailored to the user's individual taste preferences.

### RELATED APPLICATIONS

This application claims priority to U.S. Provisional Application No. 61/058,517 filed Jun. 3, 2008, incorporated herein by this reference.

### COPYRIGHT NOTICE

©2008-2009 Strands, Inc. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### TECHNICAL FIELD

This invention pertains to computer-implemented recommender technologies, and more specifically, providing user profiles that compactly describe sections of an associational knowledge base most likely be of interest to the user at any particular time, to enable services and applications to better serve the user's needs and personal preferences.

### BACKGROUND OF THE INVENTION

Others have compiled data of recent user attention to items described by a knowledge base and represented that attention in profiling structures such as the Attention Profile Markup Language (APML). APML is limited to communicating attention activity, however. It does not attempt to encapsulate user taste, as recent attention activity alone is a poor proxy for a deeper analysis of user taste.

The need remains for effective, concise modeling of user interactions with various items, in order to form compact, portable, machine-usable user profiles that express user tastes or preferences. Improved user profiles provide for enhanced user personalization over different applications.

### SUMMARY OF THE INVENTION

The following is a summary of the invention in order to provide a basic understanding of some aspects of the invention. This summary is not intended to identify key/critical elements of the invention or to delineate the scope of the invention. Its sole purpose is to present some concepts of the invention in a simplified form as a prelude to the more detailed description that is presented later.

The current invention proposes, in one embodiment, a computer-implemented method for creating a compact, machine-usable user taste profile. The method may include accessing an associational knowledge base “AKB” that stores relationships among a catalog of items in computer-usable form. The AKB has an associated categorization, i.e., it includes identification of a plurality of “categories,” wherein each category is a subset of the catalog of items, and the categories are defined based on similarity among the items within a category. Thus, a category, as used herein, is not a label or characterization of an item, as the term sometimes connotes; rather, is a grouping of multiple items, based on some metric of similarity among them. A key property of categorizations for purposes of our taste profile is that they decompose a universe of items into a set of potentially overlapping neighborhoods which can serve as the basis for localizing user preferences.

Various application programs are known, for example recommenders, that employ or are “driven by” a knowledge base, which may be an AKB. User interactions with an application, or interaction events, may be captured by an application and stored in memory. The illustrative process further calls for acquiring interaction data showing multiple users' interaction events with the items in the AKB; analyzing the interaction data so as to define a set of profile factors for describing the users' interactions, wherein each profile factor is a subset of the AKB categories; and forming a user taste profile, based on the user interaction data, and expressed as a weighted vector of the profile factors for the AKB. The user profile may be variously stored, structured and exported to other application.

Additional aspects and advantages of this invention will be apparent from the following detailed description of preferred embodiments, which proceeds with reference to the accompanying drawings.

### BRIEF DESCRIPTION OF THE DRAWINGS

FIG. 1 is a simplified communication diagram of a web server and related entities arranged to generate user profiles.

FIG. 2 illustrates nodes and edges in a graph representation of data, and defines some of the symbols used herein to describe catalog or knowledge base items and relationships among those items such as similarity metrics.

FIG. 3 is a sample graph illustrating one example of categorization of the dataset.

FIG. 4 is a simplified flow diagram illustrating aspects of a computer-implemented method for creating a compact, machine-usable user taste profile.

FIG. 5 is a simplified diagram illustrating a series of histograms H(m) that reflect user m interaction events over N observation times relative to the predetermined categories 1 . . . k of a selected knowledge base AKB.

FIG. 6 is a block diagram of the principle components of a software embodiment of a profile model analysis engine.

FIG. 7 is a simplified communication diagram illustrating use of a user taste profile to provide improved personalization on a web site.

FIG. 8 is a simplified communication diagram illustrating harvesting user interaction event data from various web sites to form a portable user taste profile, and exporting the user taste profile to provide improved personalization on another web site.

### DETAILED DESCRIPTION OF PREFERRED EMBODIMENTS

We aim to capture user experience, called interaction events, and from that experience formulate a compact, machine-usable expression of an individual user's taste or preferences, which we call a user taste profile, or simply user profile. A user profile is relative to a given associational knowledge base or “AKB”. It is the interaction events, or simply interactions with an application that is driven by that AKB that provide the raw data from which the user profile is formed. Then, the resulting user profile can be exported for use by other applications to improve user personalization.

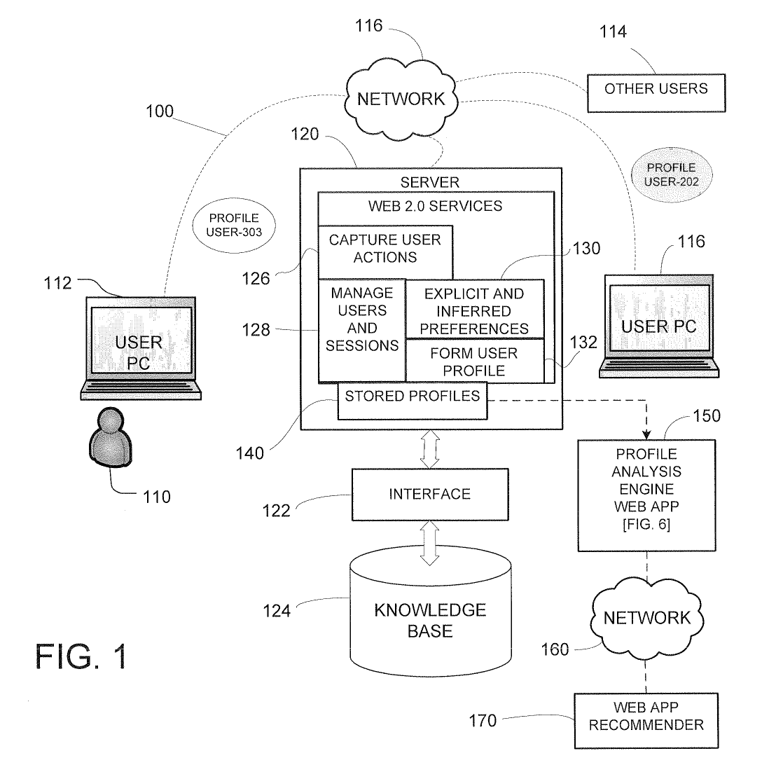

FIG. 1 is simplified communication diagram illustrating one example of an environment in which embodiments of the present invention may be used. It shows a web server arranged to generate user profiles and various related entities, coupled via a network such as the internet. The term coupled is used broadly herein to include all manner of communication methods and protocols, e.g., connection oriented, packet switched, VPN, wired, wireless, etc.

In FIG. 1, a user 110 has access to a device such as a PC 112, or any other appliance, portable, mobile or fixed, that has the requisite functionality; namely, consuming selected items, such as media items, and communicating with an entity such as a server. Here, to illustrate, the user PC 112 as well as other users 114 have access via a network 116 to a server 120 which may implement various web 2.0 services.

The server 120 has access via an interface 122 to a data store that contains a knowledge base 124. Details of data storage and access are known and therefore are omitted here. The server implements a component 128 to manage users and sessions. A “session” refers to a continuous time period during which a user, say 110, consumes or “plays” at least one, and generally a plurality, of “items” which may be media items, such a songs, on a device. The “device” may be a PC, or iPhone, laptop computer, or palm computer, or any other device capable of playing media and communicating with an application via a network. Component 128 “manages” users in order to keep track of them, and distinguish one from another. They may be identified by actual names, UIDs, device IDs etc. Preferably, a given user may have more than one player device, and the component 128 will be able to identify the user, and associate her various devices with the user's name or ID. As explained later, it may be useful, in some embodiments of the invention, to distinguish between sessions of the same user on different devices, or at different locations, in discerning the users tastes.

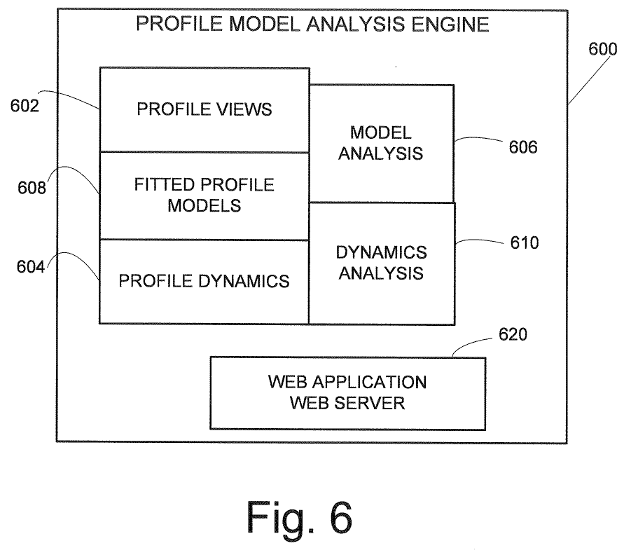

A user device (112, 114, 116) need not communicate with the server 120 (or session manager component 128) in real time. In some cases, the user's device may record user actions, for example songs played, with timestamps, for later upload to the server 120. In other embodiments, the server capture component 126 may capture record user actions, which we call interaction events, in real-time. However it may be acquired, user interaction data can be used to mine explicit and or inferred preferences of the user. This capability is represented by the preferences component 130. In a trivial example, user interaction data that reflects playing the same song multiple times each day may indicate that the user likes that song. As mentioned, however, raw interaction data is adequate to effectively, and compactly, represent user preferences. Instead, the web server 120 further includes a component 132 to form a user profile for that purpose. Details of processes for forming a user profile, for example a profile analysis engine 150, are described in detail below. A profile analysis engine may be implemented in one embodiment as a web application 150, discussed in more detail later with regard to FIG. 6. such a web application may be coupled via the internet 160 to provide services, for example, to a recommender application 170.

In an embodiment, a user's taste profile for a particular knowledge base compactly describes what sections of the knowledge base are most likely to be of interest to the user. Below we describe a mixed parametric and non-parametric Bayesian model for the user profiles and profile dynamics and describe a general computational algorithm for deriving both from observed user interactions. In another aspect, we suggest ways a user profile could be used to select items likely to be of interest to the user from a knowledge base.

In one example, the “items” of interest may be media items, such a songs or videos. A user “interaction event” may be playing a particular music item or video. Means for capturing and storing such interaction events are known. However, databases of such interaction events can grow unwieldy and in any event do not meaningfully convey user taste is a meaningful way. In one aspect of the present invention, a user profile is formed that places one user's interaction events into a larger context of many users' interactions with a dataset or catalog. Because changes over time are an important property of user preferences, the profile model also includes a model for the profile dynamics. This contrasts with many applications of PRMs that resort to elaborating static structural models for dynamic phenomena.

Preferably, the profile model assumes that the items in a knowledge base used by a web service or application can be usefully categorized in one or more ways, according to a set of explicit or implicit categories. One important idea behind the our profile is that the preferences of an individual user can be represented as factors (“profile factors”) represented as combinations of these categories, as determined by user interactions with features of a service enabled by the knowledge base. It is intended to compactly describe the sections of a specific knowledge base that are likely to be of most interest to the user at any particular time.

### Probabilistic Relational Models and Associational Knowledge Bases

The conventional Probabilistic Relational Model (PRM) is formulated with regard to a relational database (RDB). The RDB schema is conceptually reduced to a single large table where the particular data set ξₒ stored in the instantiation [symbol] of the RDB gives rise to the data rows in this table. A PRM II specifies a pattern of dependencies between some or all of the columns of this conceptual table.

In contrast to the conventional formulation of a PRM, our user profile is a PRM formulated over an Associational Knowledge Base (AKB). We define an AKB as a triple [symbol] =( [symbol] , [symbol] , [symbol] ) where, using the terminology of Description Logics, [symbol] is a universe of items uᵢ, [symbol] is a collection of concept atoms Cₗ(uᵢ), and [symbol] is a collection of role atoms Rₗ(uᵢuⱼ). An instantiation [symbol] of an AKB is just a particular instance of an AKB built from a data set ξ of ground atoms Cₗ(uᵢ) and Rₗ(uᵢuⱼ). We also define an Augmented AKB (AAKB) as a 5-tuple [symbol] =( [symbol] , [symbol] , [symbol] , σ, ρ), where σ is a function that attaches a numeric value to each atom Cₗ(uᵢ) ε [symbol] and ρ is a function that attaches a numeric value to each atom Rₗ(uᵢjᵢ) ε [symbol] . See paragraphs [0084] below for more background on AKBs.

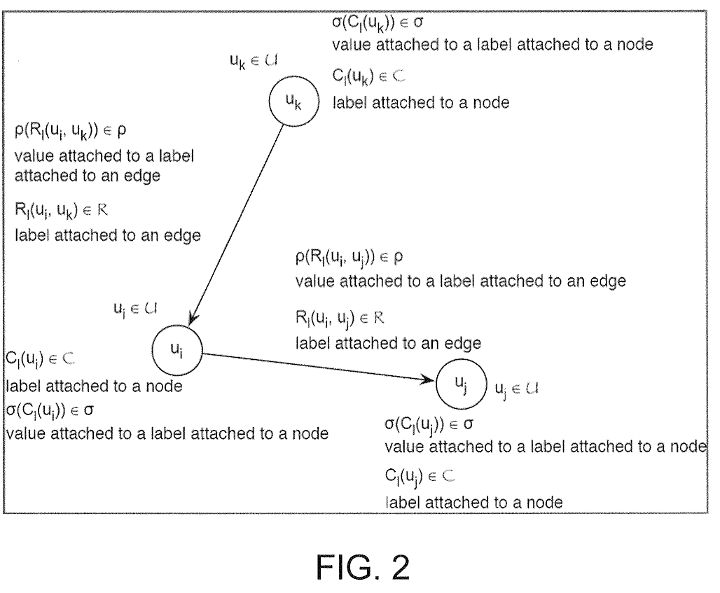

Referring now to the graph of FIG. 2, suppose uᵢ ε [symbol] is a song with title “SONG i”. A concept Cₗ(uᵢ) ε [symbol] might formally be written as “Rock(SONG i)”. This informally means “Song i has the attribute (is of the genre) Rock”. By convention, concepts start with an uppercase letter, roles start with lowercase letters and items are all capitalized—although that is not always the case. The value σ (Cl(ui)) ε σ might be a value σ (Rock(SONG i))=0.9. This informally means “Song i has the attribute Rock to the degree 0.9”.

A role Rl(ui, uj) ε R might formally be written “playlist(SONG i, SONG j)”. This informally might mean, “Song i and Song j are similar based on their co-appearances on playlists”. The value ρ(Rl(ui, uj)) ε ρ might be a value ρ(playlist(SONG i, SONG j))=0.93″. This informally means “Song i and Song j are similar according to playlists to the degree 0.93”.

### A Descriptive Model for User Interactions with an AKB

User profiles are intended to be a means for adapting the user experience in applications driven by an AKB. This is accomplished, in some embodiments, with a profile that is a dynamic probabilistic relational model of how a user interacts with applications driven by the same AKB or other AKBs that are semantically interoperable with the AKBs used to build the profile. Here we describe the construction of the dynamic PRM for user profiles from user experiences with applications driven by an AKB or more generally with items that are in the universe of a set of AKBs.

### Categorizations in AKBs

We adopt as the starting point for the user profile the idea that a profile is intended to compactly convey what portions of the knowledge in an AKB are of most interest to a user. We begin then by proposing one formal notion for how we can “divide up” the knowledge in an AKB. We define a categorization [symbol] =( [symbol] _{1,} [symbol] _{2,} . . . [symbol] _{K}) of the universe [symbol] , which we will also refer to as a multi-clustering, as a collection of subsets such that

$${C}_{} = {⋃}_{k := 1}^{K} {k}_{} ⊆ and {i}_{} ⊆ , 1 \leq i \leq K$$

A categorization differs from a partition in that we do not require [symbol] _{C}= [symbol] It also differs from a partition or a clustering in that we do not require [symbol] ᵢ ∩ [symbol] ᵢ=ø. We also note that like some clustering schemes, a categorization can induce a “leftovers” category [symbol] _{C}= [symbol] − [symbol] _{c} which is not part of the categorization proper. A key property of categorizations for purposes of the our profile is that they decompose the corresponding universe [symbol] of items into a set of potentially overlapping neighborhoods which can serve as the basis for localizing user preferences.

We can construct a categorization of an AKB in several ways. Categorizations can be based on explicit properties of the individual uᵢ ε [symbol] as described by the concept atoms in [symbol] or role atoms in [symbol] . They can also be based on implicit properties such as the patterns of relationships that come to be embodied in an instantiation [symbol] of an AKB for a particular data set ξₒ. Useful categorizations of [symbol] exist, and can easily be constructed from explicit information in the an AKB since the concepts Cₗ(uᵢ) ε [symbol] are themselves a categorization of the uᵢ ε [symbol] .

A significant class of applications for user profiles in accordance with the present invention are those which include a user experience based on a recommender application driven by an AAKB [symbol] =( [symbol] , [symbol] , [symbol] , σ, ρ). For these applications, the function p can be the basis of useful implicit categorizations. In particular, we can construct an obvious useful categorization when the role R(x, y) can be interpreted as the predicate “similar to” and ρ(Rₗ(u_{i,}uⱼ)) is a measure of the similarity between the items u_{i,} and uⱼ in the atom Rₗ(u_{i,}uⱼ). If we define categories such that ρ(Rₗ(u_{i,}uⱼ))≦c, for every pair (u_{i,}uⱼ) in every category [symbol] ₗ and some constant c, then each category [symbol] ₗ represents a cluster of “similar items”. Profiles defined relative to this type of categorization obviously provide a recommender based on semantically interoperable AKBs with significance guidance about what items to consider as recommendations.

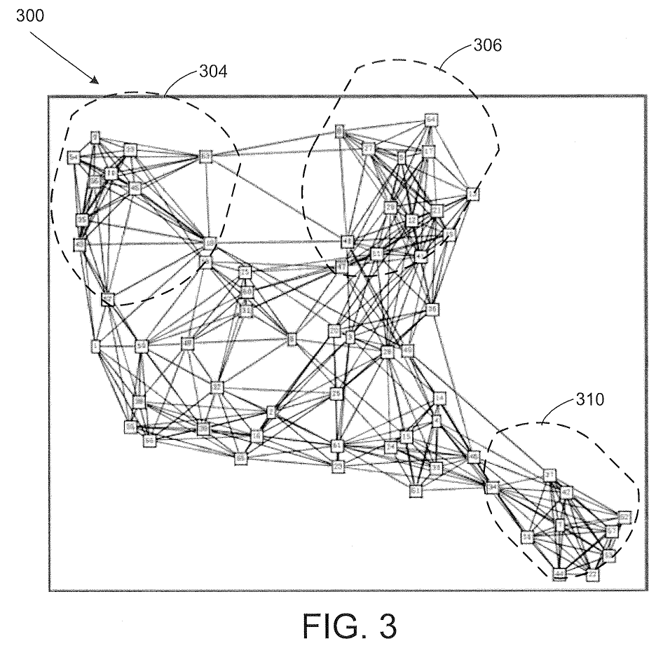

A simplified illustration of categorization is shown in FIG. 3. Here, a graph 300 represents an AKB, in which each node (a small square) represents a concept or item uᵢ and each role or edge represents a relation between items. (The nodes have numbers internally but we do not use them here.) For a given role, each edge may have a corresponding value, as explained above with respect to FIG. 2. In FIG. 3, three regions or “categories” of items are labeled 304, 306 and 310 and identified by dashed lines circumscribing the corresponding categories. As noted, they may not be exhaustive (as shown here), and they may overlap. The categories may be determined by selecting regions of the graph in which a plurality of nodes have a relatively high number of edges interconnecting them, relative to other regions, and the edges interconnecting them have relatively high similarity values, relative to other regions of the graph. In this way, each category defines a set of nodes or items in the dataset that are relatively interconnected or related to one another.

The illustration of FIG. 3 cannot be taken too literally; it merely illustrates the concept of categorization. The specific categorization in any particular case can vary considerably by varying the parameters such as the number of nodes in a category, the edge value requirements, the desired number of categories in a dataset, etc. Different categorizations may be preferred for different datasets or applications.

### User Interaction Histories

Given a categorization [symbol] defined according to the principles described above, we next develop a descriptive model for user interactions. We begin by letting [symbol] (m) denote a collection, or history, of interaction events for user m with items in universe [symbol] of an AKB. With regard to FIG. 1, we noted earlier that user interaction data can be acquired in batches or in real-time. In an embodiment of a profile model, we can develop a single profile for a set of independent AKBs used by an applications by either treating the set as a single AKB in which the universe [symbol] is the union of the universes of the individual AKBs, or we can develop individual profiles for each component AKB and combine them into a single profile. This sequence of events does not necessarily have to come from user interactions with applications driven by the AKB; it can include independent user interactions with items in from any source. Also, as will become clear from the formulation of the basic profile, we do not require knowledge of the time sequence of the interaction events for construction of the basic profile. We just require that we can group together user interactions on some sensible basis.

From the collection [symbol] (m) of user interaction events, we form a collection of subsets [symbol] ᵢ(m), where Uᵢ₌₁^{q} [symbol] ᵢ(m)= [symbol] (m) and we do not assume that [symbol] ᵢ(m) ∩ [symbol] ᵢ(m)=0 for any i ≠ j. Typically this collection of subsets would be a division of [symbol] (m) that reflects some notion of context. For instance, frequently [symbol] (m) will be an actual time sequence d(m;τ) of user interactions. When the collection [symbol] (m) is the time sequence d(m;T), we might define the subsets as:

[symbol]

ₙ(m) ={d(m; nδ), d(m; nδ−1), . . . , d(m; nδ−Δ+1)}

where δ is the delay between subsets, Δ is the length of the aggregation, such as such as an hour or a day, and we ignore partial subsets. If time sequences [symbol] (m; n) of user interactions are available, we can also formulate a dynamical model for how the basic user profile evolves over time. To support unified presentation of the models for the profile and the profile dynamics, we assume for the rest of this discussion we work with time sequences of user events d(m;r) and that the subsets [symbol] ₙ(m) are defined in this way. This is done by way of illustration and is not intended to limit the scope of the invention to a time sequence implementation.

As the next step, we reduce a user's history [symbol] (m) to a more succinct representation as a sequence of histograms that organize the history according to a categorization [symbol] of the universe [symbol] . For each subset [symbol] ₙ(m), we compute a histogram where the k-th bin of the histogram corresponds to the number of items in [symbol] ₙ(m) in the k-th category of [symbol] . The sequence of histograms captures a snapshot framed by context of a user's interactions with items in the AKB.

We capture different views of the histograms sequences for the entire user community to derive different types of user profiles. If we seek a model for user m's preferences in recent times for items in the universe of [symbol] , we would begin with a time sequence of the last N histograms for this user. We represent this sequence of histograms as a matrix

H(m; n)=|h(m; n−N+1)|h(m; n−N+2)| . . . |h(m; n)|

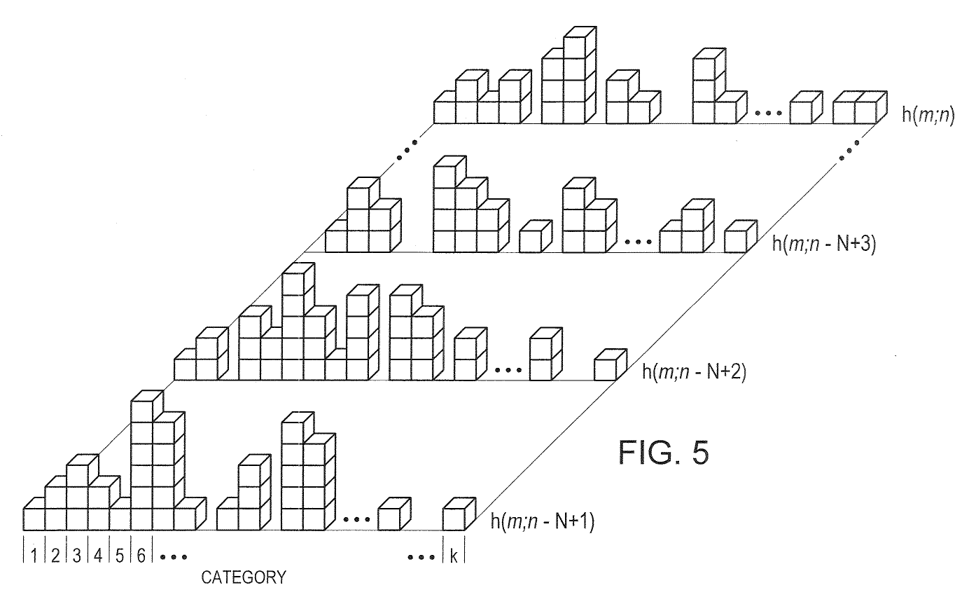

FIG. 5 illustrates such a series of histograms in pictorial form.

Similarly, if we are interested in comparatively modeling each user's preferences relative to all Musers at the present time n, we would consider the set of histograms for all users at the current time

G(n)=|h(1, n)h(2; n)| . . . |h(M; n)|

Finally, if we would like to model the preferences of each user relative to all M users in recent times, we would look to the time sequences of the last N histograms for all M users:

$$H ( n ) = [ \begin{matrix}h ( 1 ; n - N + 1 ) \vert h ( 1 ; n - N + 2 ) \vert … \vert h ( 1 ; n ) \vert \\ h ( 2 ; n - N + 1 ) \vert h ( 2 ; n - N + 2 ) \vert … \vert h ( 2 ; n ) \vert \\ ⋮ \\ h ( M ; n - N + 1 ) \vert h ( M ; n - N + 2 ) \vert … \vert h ( M ; n )\end{matrix} ]$$

The general taste profile model allows us to compute a user profile from any of these three views of the user interaction data. However, the general meaning of the profile differs in each case. When we don't have or can't reference data for a large population of users, or we just need to minimize the computational load of computing profiles, we can compute individual user profiles from H(m; n). This version of the profile may present a more detailed picture of a user's preferences than profiles computed from the other views, but we may not be able to easily compare it to the profiles for other users. On the other hand, if we are primarily interested in understanding the preferences of the entire user community and where the preferences of an individual place that individual in the community at the current time, we can compute a profile for every member of the community using the G(n) view. Finally, if we are essentially interested in profiles that accomplish both goals, and we have the data available, we can compute a profile for every member of the community using the H(n) view. Profile views 602 are shown generally in FIG. 6 as a part of a profile model analysis engine.

While all three views allow us to compute a user profile, we can also build a model for the profile dynamics from the time sequence information in the H(m; n) and H(n) views. Profile dynamics can be useful for predicting trends in individual and overall community preferences. We use the H(n) view for the rest of this description of the taste profile model because it allows us to compute profiles and profile dynamics for each individual that can be compared with those for the rest of community. Of course, this generality comes at increased computational cost compared to that for computing profiles from the other two data views. The H(m; n) data view might be a preferred choice in some large scale applications, since profiles and dynamics are computed on a per-user basis rather than in the context of the entire user community. Different mixed approaches might also be preferred in other applications. All such variations are well within the scope of the present invention. Profile dynamics 604 are shown generally in FIG. 6 as a part of a profile model analysis engine.

This approach of defining data views and fitting the PRM to that data gives rise to the concept that our user profile is based on fitting a PRM to an associational knowledge base, rather than to a relational database as in the conventional formulation of a PRM. While the histogram h(m; n) could be stored in an RDB, a more informative interpretation of a view like H(n) is as a sub-AAKB [symbol] _{H}=( [symbol] [symbol] , [symbol] , σ, ρ) created by filtering the underlying AAKB on the item nodes that appear in the histograms, and viewing the columns in the view H(n) as the range values of a vector σ function.

### The User Profile PRM

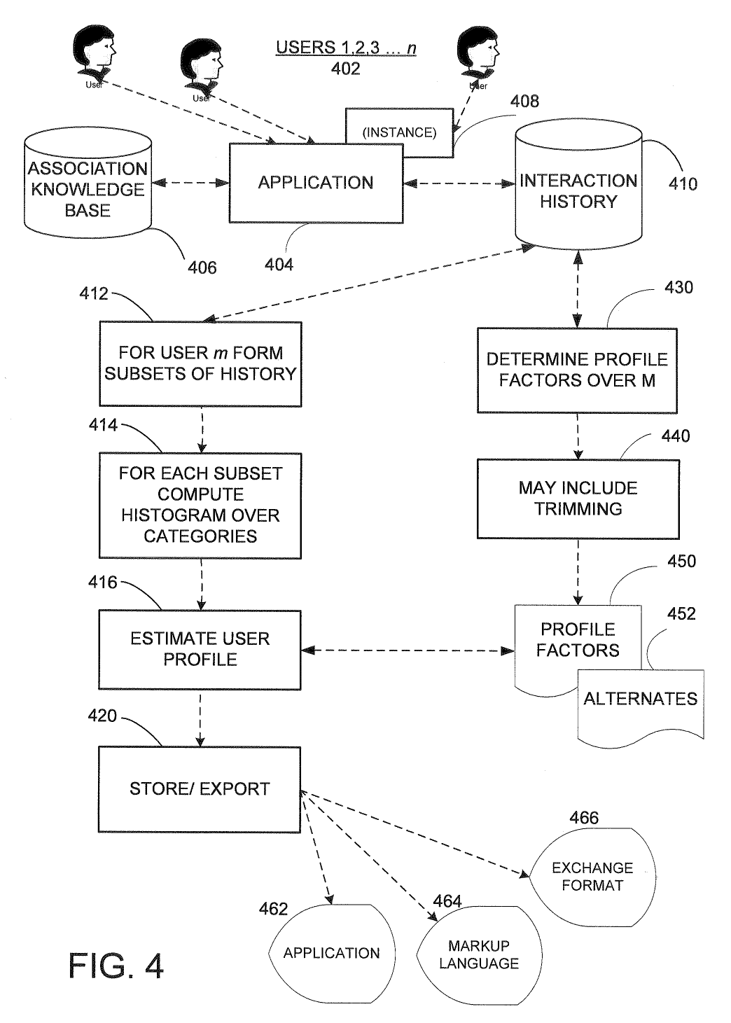

The data views described above are not themselves good candidates for a user profile: They can be kept compact only by arbitrarily limiting the amount of data they include and they do not inherently provide direct insight into a user's preferences. The profile instead fits a probabilistic relational model to a data view so that the model components are the user profile. The profile PRM also serves as the basis for the profile dynamics PRM model. Before detailing that analysis, we provide an overview with regard to FIG. 4.

FIG. 4 summarizes one embodiment of a process in accordance with the present disclosure. In FIG. 4, users 402 interact with an application 404 that may comprise, for example, a recommender application. Application 404 is driven by an associational knowledge base (AKB) 406, described elsewhere. In some cases, multiple remote users may interact with a web application. In other cases, individual user devices may execute an instance 408 of an application, again driven by the AKB. In general, the user(s) interactions with the application may be recorded in various forms, called interaction history, in a data store 410. For example, the data may be stored in flat files, relational databases, vectors, etc. The recorded history typically comprises interaction events, such a plays or media items by users of the application(s).

As discussed above, for a given user, a corresponding subset of the history data 410 can be formed as indicated at block 412. For each such subset, the process calls for computing a histogram of the interaction events over the categories associated with the AKB 406 or another compatible AKB. The histogram data may be used to estimate individual user profiles, as described in more detail above, indicated at block 416.

In an embodiment, the left path below 410 computes H (the histogram) at 414 and solves for X(n) at 416. The right path under 410 finds F(n), the factors that are used in 416 to estimate the user profile. In another embodiment, H(n) may be determined by solving for F(n) and X(n) simultaneously. In either case, the resulting user profile may be stored, block 420, and or exported in various machine-readable forms, further discussed below. Referring again to the interaction history data at 410, it is processed over all users, at block 430, to determine a set of profile factors, as discussed earlier. The set of factors may be limited or trimmed, indicated at block 440, to control the size and complexity of individual user profiles. Thus the drawing indicates profile factors at 450, and optional alternative sets of factors at 452. Finally, the user profiles may be exported to other applications, block 462; in the form of a markup language, block 464, or using other exchange formats indicated generally at 466. These steps are explained in more detail below.

One large class of non-linear probabilistic models for a random data set like the histogram data view H(n) has the form

H(n)=g(F(n), X(n))+W(n)

In this model, F(n) is a matrix whose L columns are K-dimensional random vectors. These factors represent the hypothesis that preferences can be usefully described in terms of L<M N factors (latent variables), where each factor corresponds to some subset of the K categories in the categorization [symbol] of the universe [symbol] . The matrix X(n) has M N columns (for this specific H(n) which includes N histograms for each of M members), where each column is an L-dimensional vector of coefficients indicating how much each profile factor contributes to the observed user interactions summarized by the corresponding histogram in H(n). Finally, W(n) represents additional random variations in how user preferences are expressed in the observed interactions.

### The Linear Profile Model

Our profile postulates that the user interactions, as organized into the data view H(n) are sufficiently described by the linear model

H(n)=F(n)X(n)÷W(n)

In the simplest case, F(n) would actually be a deterministic matrix F(n) representing a known set of profile factors based on some generative model for user preferences. The problem of computing the user profile would then reduce just to computing the contributions X(n), in effect describing the contributing factors a user's expressed preferences in a context for which we have a specific histogram h(m; n). The next most ideal situation would be where we just know which elements of each profile factor represented by a column of F(n) are non-zero. In that case, the chief problem still is to estimate X(n), and in some cases we might want to also estimate values for the non-zero elements of F(n) to get some sense of the relative importance of each category [symbol] ᵢ in each profile factor.

In the general case, we won't know anything more about F(n) or X(n) than the form of the probability distributions for the components. Although many applications of PRMs also assume that the form of the probability distribution of W(n) is known, as explained later the present profile model does not. Instead the model uses non-parametric methods to avoid dealing with W(n) explicitly. In this case, we want to use the joint probability distribution for the components of the model:

$$\begin{matrix}Pr ( H ( n ) , F ( n ) , X ( n ) ) = Pr ( H \vert F , X ) Pr ( F ) Pr ( X ) \\ = {\prod }_{k = 1}^{K} {\prod }_{j = 1}^{MN} Pr ( {H}_{kj} \vert F , X ) \cdot \\ {\prod }_{k = 1}^{K} {\prod }_{l = 1}^{L} Pr ( {F}_{kl} ) \cdot {\prod }_{l = 1}^{L} {\prod }_{j = 1}^{MN} Pr ( {X}_{lj} )\end{matrix}$$

to derive estimates for the structure and values in F(n) and the values in X(n), as well as the parameters of their respective probability distributions, given just an observation of H(n). This is obviously computationally hardest version of the problem of fitting the profile model to the user interaction data. On the other hand, the solution to this version of the fitting problem also yields valuable information about the structure of audience and individual user preferences in the form of the estimated F(n) that may not be known or otherwise available.

In a presently preferred embodiment of our profile model, we make the most minimal assumptions possible on the three probability distributions involved, the conditional distribution Pr(Hₖⱼ|F,X), and the prior distributions Pr(Fₖₗ) and Pr(Xᵢⱼ). We in fact don't assume we have a parametric distribution for Pr(Hₖⱼ|F,X) and use non-parametric methods in the portion of the profile computations that involve this CDF. For the general formulation of the model solution, we assume that Pr(Fₖₗ) is a parametric distribution with a parameter vector ψₗ=Ψ(H,F,X) that is associated with profile factor (column of F(n)) and not the category [symbol] ₖ. Similarly, we assume Pr(Xₗⱼ(n)) is a parametric distribution with a parameter vector φⱼ=φ(H,F,X) that is associated with the histogram instance in the view H(n) (column of H(n) and X(n)) and not the factors fₗ(n).

### Model Solution

Solving the profile model is a type of non-linear multi-variable optimization problem. This problem, is an instance of the class of optimization problems concerned with probabilistic models that frequently are efficiently solved using variants of the Expectation Maximization EM method. The EM method addresses problems in which we are given a probabilistic model for a data set and an incomplete sample, and we seek optimal point-estimates for hidden data values and point-estimates for the parameters of all probability distributions in the model. While the point-estimates for the parameters of the probability distributions in the model solved by the EM algorithm gives us a full description of the probability distributions for the hidden data, technically the basic EM approach is a non-Bayesian method because it does not yield estimates of the prior distributions for the parameters of the probability distributions in the model being solved. However, it is straightforward in principle to convert many models solvable using EM to full Bayesian models by simply considering the parameters of the probability distributions in the model to be part of the missing data, and providing priors for those parameters so that the point-estimates for distribution parameters computed by the method are actually for the parameters of the priors. The problem of finding structural features of the model, such as frequently arises in fitting a PRM to data as we are doing with our user profile, can also be cast as estimating hidden data within the EM method.

Others have proposed a non-parametric maximum likelihood estimator for the probability distribution of a random variable that has a specified mean μ from a data sample. Using an estimator we can construct an empirical likelihood ratio function for estimates of the hidden data F(n)=F and X(n)=X given the data H(n)=H.

$$R ( H ; F , X ) = max \{ \begin{matrix}{\prod }_{j = 1}^{MN} {MNw}_{j} \vert {\sum }_{j = 1}^{MN} {w}_{j} ( {h}_{j} - {Fx}_{j} ) = 0 , \\ {w}_{j} \geq 0 , {\sum }_{j = 1}^{MN} {w}_{j} = 1\end{matrix} \}$$

where hⱼ and xⱼ are the j-th column of H and X, respectively, we can use in a version of the expectation maximization algorithm to solve for the taste profile.

The EM formulation for solution of the taste profile model is straightforward. We are given the incomplete data set H(n) and some information about the form of the probability distributions discussed above, and we want to estimate the hidden data F(n) and X(n) in the model, along with the parameter vectors w=|w1 . . . w_{MN}|, ψ=|ψ₁ . . . |ψ_{L} and φ=φ1 . . . φ_{MN}|. EM is an iterative two-step method. In the first, or E-step, the current values of the parameters are used to compute improved estimates for the hidden data F(n) and X(n). The second, or M-step, computes optimal estimates for the parameters w, ψ, and φ given the estimates for the hidden data from the E-step. The process repeats until the computation converges, as indicated by the magnitude of the changes in the values of the hidden data and the parameters between successive iterations falling below some threshold.

### E-Step

The E-step finds values F(n)=F and X(n)=X of the hidden data that optimizes the conditional probability

$$\begin{matrix}Pr ( F , X \vert H , w , ψ , φ ) = \frac{Pr ( H , F , X \vert w , ψ , φ )}{Pr ( H \vert ψ , φ )} \\ = \frac{Pr ( H \vert F , X , w , ψ , φ ) Pr ( F \vert ψ ) Pr ( X \vert φ )}{Pr ( H \vert p , φ )} \\ ∝ L ( H \vert F , X , w , ψ , φ ) Pr ( F \vert ψ ) Pr ( X \vert φ )\end{matrix}$$

Here L(y|x) is the likelihood function, which in this case is just an alias for Pr(y|x), and H(n)=H is the observed data value. The proportionality of the left and right sides of the last equation comes about because the denominator probability Pr(H|ψ,φ) is constant in this step of the method, and therefore does not affect the values F and X which maximize Pr(F,X|H,ψ,φ).

As already noted, the our user profile model does not assume the likelihood function has a parametric description, rather we use the empirical likelihood ratio function to compute the estimates of the hidden data F(n) and X(n). In the E-step, we use the observed data H and the values for w, ψ, and φ from the previous M-step to construct a nonlinear programming problem in which we maximize

$${Q}_{E} ( H , w , ψ , φ ; F , X ) = {\prod }_{j = 1}^{MN} {MNw}_{j} \cdot Pr ( F \vert ψ ) Pr ( X \vert φ )$$

subject to the constraints

$${\sum }_{j = 1}^{MN} {w}_{j} ( {h}_{j} - {Fx}_{j} ) = 0 \qquad {F}_{kl} \geq 0 \qquad {X}_{lj} \geq 0$$

and initial conditions

wⱼ=1/MN ψₗ=1/L φⱼ=1/MN

for the estimates F(n)=F and X(n)=X.

An important part of computing F and X is deriving a reasonable estimate for the structure of non-zero and zero elements of F. In our model, F and X are constrained to be non-negative, but F does not have to be a binary matrix. A general algorithm for estimating F and X, is to first use a nonlinear system solver to estimate F and X that are both non-negative, set the elements of F with values below a threshold to zero, and finally use the nonlinear system solver again to compute a non-negative X and a non-negative F with the specified zero elements. Some cases may inherently be solvable by deterministic or probabilistic algorithms which are more efficient than this simple algorithm, or allow the imposition of constraints on F, which make them so.

### M-Step

Given the current estimates from the E-step, the goal of the M-step is to find the vectors of values w, ψ, and φ which maximize the marginal probability

$$Pr ( w , ψ , φ \vert H ) = {\sum }_{F , X} Pr ( w , ψ , φ , F , X \vert H )$$

In the generic algorithm, this is actually done by finding w, ψ, and φ which maximize a particular lower bound function

$$Q ( H , {w}^{′} , {ψ}^{′} , {φ}^{′} ; w , ψ , φ ) = {\sum }_{F , X} Pr ( F , X \vert H , {w}^{′} , {ψ}^{′} {φ}^{′} ) log Pr ( H , F , X \vert w , ψ , φ ) + log Pr ( w , ψ , φ ) - {\sum }_{F , X} Pr ( F , X \vert H , {w}^{′} , {ψ}^{′} {φ}^{′} ) log Pr ( F , X \vert H , {w}^{′} , {ψ}^{′} , {φ}^{′} )$$

for Pr(w,ψ,φ|H) that is a function of the values w′, ψ′, and φ′ from the previous iteration.

In an embodiment of our profile model, we instead rewrite the cost function by taking advantage of the known relationship W(n)=H(n)−F(n)X(n) between H(n), F(n), and X(n), where W(n) is a zero-mean random variable, so that

$$\begin{matrix}Pr ( w , ψ , φ \vert H ) = {\sum }_{F , X} Pr ( H \vert F , X , w , ψ , φ ) \\ Pr ( F , X \vert w , ψ , φ ) Pr ( w , ψ , φ ) / Pr ( H ) \\ = {\sum }_{F , X} Pr ( H \vert F , X , w , ψ , φ ) Pr ( F \vert ψ ) \\ Pr ( X \vert φ ) / Pr ( H ) \\ ∝ Pr ( W \vert w , ψ , φ ) Pr ( F \vert ψ ) Pr ( X \vert φ )\end{matrix}$$

We can ignore Pr(H) in the last expression because it does not depend on w, ψ, or φ. In addition, we reduce the summation to the terms shown in the estimates F and X from the E-step, and the computed value W=H−FX because EL methods only place probability on sample values.

To find estimates for w, ψ, and φ, we first find ψ and φ independently since they only depend on the estimates F and X. We then compute w implicitly by constructing a nonlinear programing problem from the empirical likelihood function R(H; f) in which we maximize

$${Q}_{M} ( H , F , X ; w , ψ , φ ) = {\prod }_{j - 1}^{MN} {MNw}_{j} \cdot Pr ( F \vert ψ ) Pr ( X \vert φ )$$

subject to the constraints

$${\sum }_{j = 1}^{MN} {w}_{i} ( {h}_{j} - {Fx}_{j} ) = 0 \qquad {w}_{j} \geq 0 \qquad {\sum }_{j = 1}^{MN} {w}_{j} = 1$$

for w.
Considerations about Algorithmic Convergence

In the generic EM algorithm, the cost function Q (H, w′,p′,φ′; w,ψ,φ) is designed to guaranty that the algorithm converges to a local optimum. We don't give a formal proof here that this instance of the EM algorithm based on empirical likelihood methods converges. We note though, that algorithm simply attempts to find F,X,w,ψ, and φ that maximize the total cost function

$$Q ( H ; F , X , w , ψ , φ ) = {\prod }_{j = 1}^{MN} {MNw}_{j} \cdot Pr ( F \vert ψ ) Pr ( X \vert φ )$$

subject to the combined constraints

$$\begin{matrix}{\sum }_{j = 1}^{MN} {w}_{j} ( {h}_{j} - {Fx}_{j} ) = 0 & {w}_{j} \geq 0 & {\sum }_{j = 1}^{MN} {w}_{j} = 1 & {F}_{kl} \geq 0\end{matrix} \qquad {X}_{lj} \geq 0$$

where ψ and φ are bounded parameters of closed-form probability distributions, in a sequence of alternating E and M steps.

In a simple model, we assume that Pr(Fₖₗ) is a Bernoulli distribution where ψ₁ is a scalar parameter Pₗ=η(fₗ)/L, where η(f) is the number of non-zero entries in a factor f. We also assume that Pr(Xₗⱼ(n)) is an arbitrary fixed distribution which does not include a parameter φⱼ. This means that the M-step only optimizes the EL weight vector w and the Bernoulli parameter vector ψ.

For a model with these properties, the cost function Q(H; F,X,w,ψ,φ) increases monotonically as the number of non-zero entries in F decreases. This algorithm insures this quantity is non-decreasing in the E-step. Q(H; F,X,ω,ψ,φ) could decrease in the M-step if the number of non-zero entries increases in one or more factors fₗ in the E-step. However, for the E-step to be non-decreasing this cannot be the case so the M-step must also be nondecreasing. This implies the algorithm will converge in the sense that it will terminate once the changes in either the cost function Q(H;F;X,ω,ψ,φ) or alternatively F,X,ω,ψ, and φ, eventually fall below appropriate thresholds. Even if those values are not a true local maximum of the involved probability models, they will be reasonable choices for the user profile. Profile model analysis component is represented by block 606 in FIG. 6 as a part of a profile model analysis engine. The resulting fitted profile models are indicated at block 608.

### Profile Dynamics

Once we have profile estimates for an individual m; we can also easily construct a simple linear dynamical model for how the profile for an individual changes over time. This model admittedly is synthetic in that it does not draw on any evidence suggesting that the dynamics are linear, nor any deeper theory of why or how a user's profile should change over time. At the same time it is a starting point for further investigation of models for the dynamics that are rooted in deeper science, and into a unified profile model that incorporates dynamics. In essences, the basic profile model simply assumes that the profile dynamics are static. A unified profile will include a model for non-static dynamics.¹ ¹ In essence, the basic profile model simply assumes that the profile dynamics are static. A unified profile will include a model for non-static dynamics.

For the dynamics model, we let Xₘ(n) denote the submatrix of X(n) consisting of the N columns for user m. The time-varying linear model for the dynamics has the form

Xₘ(n)=G(n)Xₘ(n−1)+U(n)+V(n)

where G(n) is a deterministic transition relation, U(n) is a deterministic driving process and V(n) is an arbitrary zero-mean noise process. In a more complex Bayesian model, we could assume that G(n) and U(n) are actually probabilistic matrices or could have some structure. Since this dynamical model is synthetic, there is no persuasive reason for elaborating on this basic model. Instead we represent any model uncertainty by the noise process V(n).

The dynamical model is solved by first using least-squares methods to find G(n) and U(n). Given solutions for those quantities, we resort again to empirical likelihood methods to estimate the probability density for the column vectors of V(n). We define the empirical likelihood function for G and U at each time n given the current and unit time lagged profile estimates Xₘ(n)=X and Xₘ(n−1)=X⁽⁻¹⁾ as

$$R ( X , {X}^{[ - 1 ]} ; G , U ) = max \{ \begin{matrix}{\prod }_{j = 1}^{N} {Nw}_{j} \vert {\sum }_{j = 1}^{N} {w}_{j} ( {x}_{j} - {Gx}_{j}^{[ - 1 ]} - U ) = 0 , \\ {w}_{j} \geq 0 , {\sum }_{j = 1}^{N} {w}_{j} = 1\end{matrix} \}$$

The resulting estimates for G(n), U(n), and the distribution of V(n) may yield interesting insights into the potential preferences of users. Dynamics analysis component is represented by block 610 in FIG. 6 as a part of a profile model analysis engine 600.

### Some Applications of the User Taste Profile

Next we briefly suggest a few ways that estimates for the profile factors F(n)=F, the profile Xₘ(n)=X for user m, and the components G and U of the profile dynamics at time n, can be used to highlight items from an associative knowledge base that are likely to be of interest to a user.

### Selecting Items of Current Interest

The profile dynamics give an indication of the trends in a user's interests, at least with regard to profile factors for the whole audience. As we noted, the methods for estimating the profile factors can also be applied to the user data view H(m;n) in the obvious way to derive a similar dynamical model describing the user's interests with regard to personal profile factors. Using the dynamical model, the user's profile can be approximately projected some number of time steps q into the future as

$${x}_{1}^{[ q ]} = {G}^{q} {x}_{1} + {\sum }_{i = 0}^{q - i} {G}^{i} {u}_{1}$$

where u₁ is the first (most recent) column of U. The projected profile can then be used as with the previous case to select items of interest.

### Filtering Items of Current or Potential Future Interest

Another application of the profile would be to select items from a larger set of items of potential interest. In this case we would have a set S items generated by an independent process. The entire current profile Xₘ(n) or projected profile x_{m;1}(n+q) for a user can be used to indicate the categories of items to select from S that are likely to be of interest to the user.

### Profile Sharing

A user profile X can also be used for sharing user preferences developed in applications driven by one AKB [symbol] ₁ that has categories [symbol] ₁ with an application driven by a second AKB [symbol] ₂ that has categories [symbol] ₂. If the number c( [symbol] ₁, [symbol] ₂)=| [symbol] ₁ ∩ [symbol] ₂| the two categorizations have in common is sufficient for the application, X could be used directly as previously suggested.

If the two categorizations do not have enough categories in common, we can consider a semantic mapping scheme. One simple scheme is based on deriving a mapping ψ: P( [symbol] ₁)→P( [symbol] ₂) between the categories of [symbol] ₁ and [symbol] ₂, where P(S) is the power set of S. This derivation can be automated if the definitions of the two AKBs are expressed in a semantically interoperable way using OWL or other semantic web ontology technologies. Using this mapping, we can compute the structural pattern S₂ of non-zero and zero elements in a synthetic profile factor matrix for F₂ for [symbol] ₂ from the profile factor matrix F₁X₁ for [symbol] ₁. The new profile X₂ can be derived by refactoring the product \grave{H}₁=F₁ using the structure S₂ in a variant of the E-M algorithm. Another simple algorithm would use the mapping P(S) to create a synthetic data view \grave{H}₂ with categories [symbol] ₂ from \grave{H}₁ and then factor that using the basic EM algorithm.

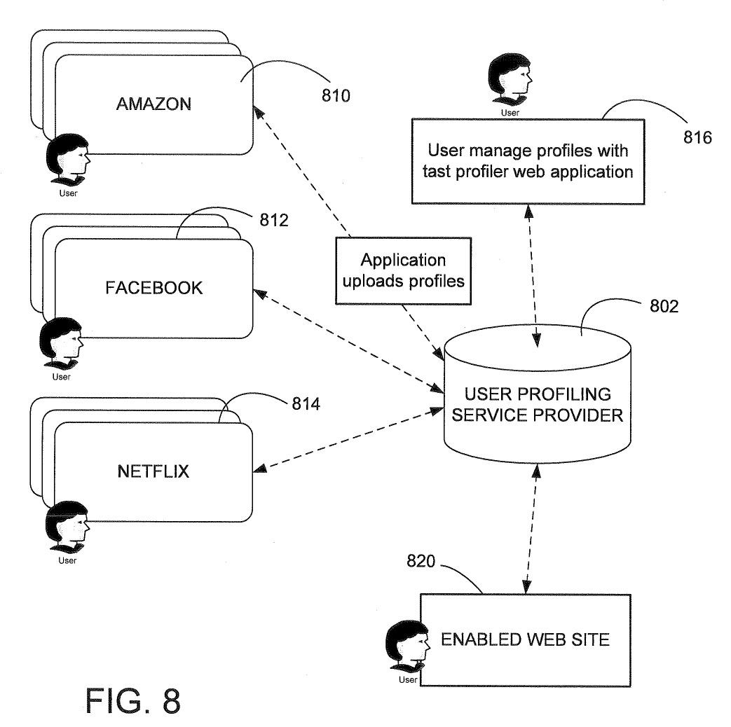

FIG. 8 is a simplified communication diagram illustrating harvesting user interaction event data from various web sites to form a portable user taste profile, and exporting the user taste profile to provide improved personalization on other web sites. For example, web sites 810, 812 may be enabled to acquire user interaction data, such as book or music online purchases, or social interactions. Such information may be used as discussed above to form user profiles. On the other hand, user profiles maintained at a service provider 802 may be downloaded to a web site 814 in order to immediately personalize the user's experience by taking advantage of the available profile. As noted above, the profiles may be based on the same AKB or on any compatible AKB to which the necessary parameters may be mapped or adapted. As one example, interactions on Facebook 812 may include discussions of films. User data may be used to form an AKB of a catalog of films. The profile may be used by Netflix 814 or any other purveyor of film media items to drive a recommender to make appropriate recommendations for that user.

### User Affinity

User profiles Xₘ(n)=Xₘ developed from the H(n) data view are compact description of users preferences that can easily be compared in obvious ways to determine affinities between users. For instance, given the most recent profiles x_{1,}x₂ (first column of X₁ and X₂) for two users, one can simply take the normalized dot product

$$\frac{〈 {x}_{1} , {x}_{2} 〉}{{〈 {x}_{1} , {x}_{1} 〉}^{1 / 2} {〈 {x}_{2} , {x}_{2} 〉}^{1 / 2}}$$

as a measure of affinity between the two users. Similarity measures based on other vector comparison methods, and selectively comparing profile components are also possible.

As already described, the dynamical model described by the pair of matrices Gₘ and Uₘ can be used to predict the user's profile Xₘ in the future. This suggest that the dynamical model can be used to determine developing affinity between two users. Future work on elaborating the dynamical model can lead to additional methods for predicting future affinity.

The profile factors Fₘ(n) developed for two users from the H(m;n) data view can also be the basis for assessing user affinity. Affinity may exist between users with one or more similar profile factors. Variants of the methods for using the profile and profile dynamics as just described for the H(n) data view can also be applied to profiles and profile dynamics computed from the H(m,n) data view.

### Group Profiles

Given a collection of user profiles [symbol] (n) at some time computed from the n H(n) data view, we can compute a weighted group profile formally expressed as

$$X \cdot = \frac{{\sum }_{{X}_{m} ∈}^{ } {α}_{m} {X}_{m}}{{\sum }_{{X}_{m} ∈ ( n )} {α}_{m}}$$

where 0≦αₘ. Any number of ways can be used to determine how to give greater weight to the profiles from some group members relative to others. Of course, one can develop a number of other ways to develop group profiles from the dynamical models and the factor matrices akin to those described for user affinity.

### Associational Knowledge Bases

Our user profile is designed to be a compact description of the sections of a particular associational knowledge base (AKB) that are likely to be of most interest to the user. Since we are not concerned here with building associational knowledge bases or in how they can be used by applications such as recommenders, we only need a simple abstraction for them that we can refer to in formulating the profile model. Rather than use the conventional database model for PRMs, we use an alternate, simpler formulation that more directly describes an associational knowledge base. Using the framework of Description Logics, we define an associational knowledge base to be a triple [symbol] =( [symbol] , [symbol] , [symbol] ) where [symbol] is a universe of items uᵢ, [symbol] is a collection of concepts, Cₗ and [symbol] is a collection of roles Rₗ. We will also refer to concepts and roles as properties and relations, respectively. An instantiation [symbol] of an associative knowledge base is a collection of instances of concepts Cₗ(uᵢ), and a collection of instances of relations Rₗ(uᵢ,uⱼ).

We can help fix ideas about the knowledge in relational databases (RDB) treated by PRMs and the knowledge in AKBs by examining the connections between them. A superficial approach could be to simply consider [symbol] to be a single table (class) C with just the two attributes C.Name and C.Subject. Similarly, [symbol] could be a single table (class) R with just the three attributes R.Name, R.Subject and R.Object. While one could build a PRM for such a database, it would not be a very transparent representation for the knowledge represented by an instantiation of an AKB contained in the RDB.

A better approach would be to represent the AKB by an RDB instantiation with a schema that has a natural and expressive relationship to the knowledge in the AKB. It turns out this can be a difficult problem, depending on just how expressive we desire the RDB to be of the knowledge contained in an AKB instance. At one extreme is the case where the AKB conforms to a full-blown ontology, such as might be specified using OWL, and we desire an RDB that is tuned to store the knowledge in the AKB in the most expressive way possible. This would generally require mapping ontological features into the relational structure of the tables and table attributes to support the full spectrum of reasoning over the RDB that is possible with the AKB.

Since we only want to gain some insight into how our profile model fits into the general PRM framework, we consider a simpler representation for an AKB as an RDB. In this representation, each concept C ε [symbol] corresponds to a table C in the RDB schema. An appropriate subset of the roles [symbol] (C)=R₁, R₂, . . . , Rₗ, where [symbol] (C) [symbol] [symbol] correspond to the columns (attributes) R₁, R₂, . . . , Rₗ of the table C. This simple representation is not necessarily easy to construct, nor is it necessarily unique because the set of roles [symbol] (C) corresponding to columns in the table associated with concept depends on how much of the structure of the knowledge in the AKB that we wish to capture in the RDB schema. If we know the relationships between the concepts [symbol] and the roles [symbol] , translating an AKB to an RDB representation is not computationally difficult. In contrast, inferring those relationships from the data could be as difficult as estimating missing data and parameters in a probabilistic model. This is because the AKB does not have to include an atomic instance for every concept-role pair represented by a row-column value (the AKB does not have to be complete relative to the RDB), and concept-role atom pairs can correspond to multiple row-column values in the RDB.

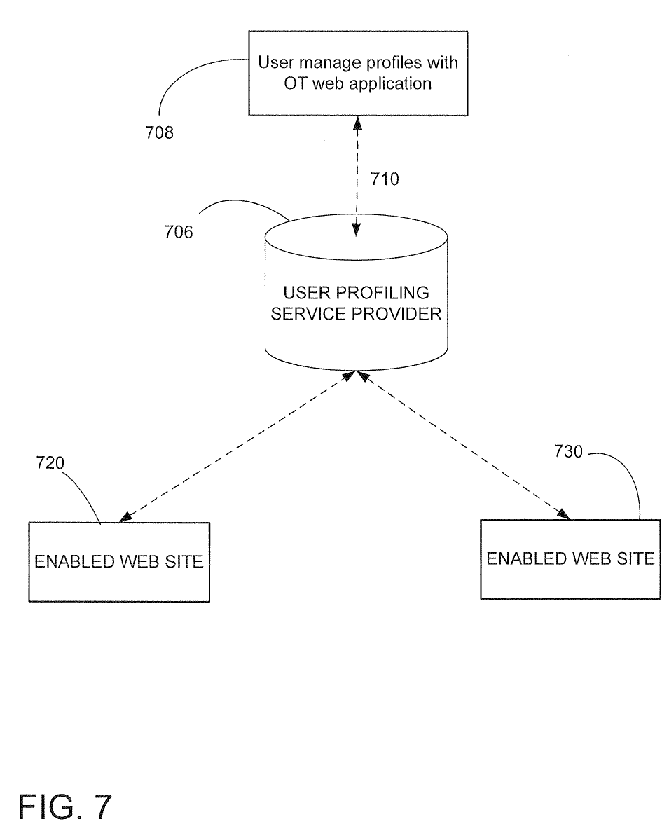

FIG. 7 illustrates use of a user taste profile to provide improved personalization on a web site. Here, a user profiling service provider 706 may be implemented on a network, for example the Internet, to provide services, including creating, maintaining, updating and exporting user profiles of the kinds described above. A user may manage her profiles by accessing the service 706 using a suitable application program (or plug-in, widget, etc) 708, communicating over the network 710. The user profile may be exported to an enabled website 720, 730 as desired. Consequently, the user may experience improved personalization at the sites that receive and employ the profile. Conversely, a suitably enabled web site may record user-interactions to acquire information useful in creating the user's profile.

1. A computer-implemented method for creating a compact, machine-usable user taste profile comprising the steps of:
accessing an associational knowledge base AKB that stores relationships among a catalog of items in computer-usable form, the AKB including identification of a plurality of categories, wherein each category is a subset of the catalog of items, and the categories are selected based on similarity among the items within a category;
providing an application for use by users, wherein the application uses the AKB to provide services to the users;
acquiring interaction data showing multiple users' interaction events with the items in the AKB;
analyzing the acquired interaction data so as to define a set of profile factors for describing the users' interactions, wherein each profile factor is a subset of the AKB categories;
forming a taste profile expressed as a weighted combination of the defined profile factors; and
storing the taste profile as a file, vector, table or other machine-usable data structure.

2. A computer-implemented method according to claim 1 wherein the AKB categories are selected by identifying regions of a data graph in which the catalog items, represented as nodes in the graph, have a relatively high number of edges interconnecting them, relative to other regions, the edges interconnecting the nodes have relatively high similarity weights, relative to other regions of the graph, or a combination of the number of edges and similarity weights.

3. A computer-implemented method according to claim 1 wherein the number of categories is a predetermined, fixed number, notwithstanding subsequent growth of the number of items in the AKB.

4. A computer-implemented method according to claim 1 and further comprising:
selecting the stored interaction event data for a selected one of the users m; and
computing a histogram of the selected events according to the categorization defined in the AKB, to the extent that the items identified in the interaction events fall within at least one of the categories, so that the k-th bin of the histogram corresponds to the number of items in the user m interaction events that fall within the k-th category of the items in the AKB.

5. A computer-implemented method according to claim 4 and further wherein said forming a taste profile comprises forming an individual taste profile for user m by fitting the histogram of user m interaction events to the defined set of profile factors, and storing the resulting user m profile as a data structure that includes a weighted combination of the defined profile factors.

6. A computer-implemented method according to claim 5 wherein the user profile model is fit to the user interaction data histogram by decomposing that histogram into a vector product of estimates for the defined profile factors that have specified properties and estimates for relative weights of those factors that have specified properties.

7. A computer-implemented method according to claim 6 wherein the decomposition is done using an expectation-maximization process which estimates the profile factors and the relative weights.

8. A computer-implemented method according to claim 4 and further comprising:
forming a second taste profile for a second user n from user n's interaction events with the items in the AKB; and then
comparing the resulting user taste profiles of user m and user n to form a measure of affinity between the two users.

9. A computer-implemented method according to claim 8 wherein the user taste profiles are based on different AKB's having different profile factors, and said comparing the user taste profiles of user m and user n to form a measure of affinity includes comparing the respective profile factors.

10. A computer-implemented method according to claim 1 and further comprising:
selecting the stored interaction event data for a selected one of the users m; and
partitioning [grouping] the selected user m interaction event data into a collection of subsets of interaction events, wherein the subsets are selected so as to reflect a common context among the events within each subset.

11. A computer-implemented method according to claim 10 and further comprising, for each subset of user m interaction events, computing a corresponding histogram of the events according to the categorization defined in the AKB, to the extent that the items identified in the interaction events fall within at least one of the categories, so that the k-th bin of the histogram corresponds to the number of items in the subset of interactions that fall in the k-th category of the items in the AKB.

12. A computer-implemented method according to claim 11 and wherein each of the subsets of interaction events corresponds to a respective time period; and further comprising arranging the interaction event subsets, or the corresponding histograms, into chronological order, to form a sequence of data, and then projecting the user profile a selected number of steps into the future, so as to form a projected profile that may be used for selecting items of potential future interest to the user.

13. A computer-implemented method according to claim 1 and further wherein the application is a recommender for media items, and the items in the AKB correspond to a catalog of media items, and the user interaction events are plays of individual media items in the AKB.

14. A computer-implemented method for personalizing applications driven by knowledge bases, comprising:
accessing a first associational knowledge base AKB-1 that stores relationships among a first catalog of items U-1 in computer-usable form, the AKB-1 including identification of a first set of categories C-1, wherein each category of C-1 is a subset of the first catalog of items U-1, and the categories are selected based on similarity among the items of U-1 within a category;
accessing a second associational knowledge base AKB-2 that stores relationships among a second catalog of items U-2 in computer-usable form, the AKB-2 including identification of a second set of categories C-2, wherein each category of C-2 is a subset of the second catalog of items U-2, and the categories are selected based on similarity among the items of U-2 within a category;
acquiring interaction data showing user interaction events with the items in the first AKB-1;
analyzing the acquired interaction data so as to define a first set of profile factors for the first AKB-1, wherein each profile factor is a subset of the AKB-1 set of categories C-1;
forming a first taste profile expressed as a weighted combination of the defined profile factors;
storing the taste profile as a file, vector, table or other machine-usable data structure;
comparing the first and second sets of categories C-1, C-2 to identify categories in common; and
if the number of categories in common to AKB-1 and AKB-2 exceeds a selected threshold,
exporting the first taste profile for use by an application program driven by the second AKB-2, wherein the threshold number of common categories is chosen as sufficient for the application.

15. A computer-implemented method according to claim 14 and further comprising:
if the number of categories in common to the AKB-1 and the AKB-2 does not exceed the selected threshold, deriving a mapping of the categories C-1 of AKB-1 to the categories C-2 of AKB-2;
and applying the derived mapping to create a second user taste profile, based on the first user profile, for use in the application driven by the second AKB.

16. A computer-implemented method according to claim 15 including automating the mapping derivation where the respective definitions of first and second AKBs are expressed in semantically interoperable way using a semantic web ontology technology.

17. A computer-implemented method according to claim 14 and further comprising:
examining the user taste profile expressed as a weighted vector of profile factors;
selecting at least one of the profile factors having a weighting higher than the other weightings in the user taste profile;
determining the AKB-1 categories that correspond to the selected profile factor; and
forming a second taste profile expressed as a weighted combination of the selected profile factors.

18. A computer-implemented method according to claim 17 and further comprising:
selecting items from the second catalog U-2 of the AKB-2 based on the second user taste profile.

19. A system comprising:
a first web interface to acquire interaction data from a first web service for a specific user m, wherein the first web service is enabled to store interaction data that reflects user m interaction events with a catalog of items that are represented in a selected associational knowledge base AKB;
a user profiling web application program executable on a server and coupled to receive the user m interaction event data from the first web service, and from that data to form a user m taste profile expressed as a weighted vector of predetermined profile factors associated with the AKB; and
a second web interface to download the user m taste profile to a second web service to enable the second web service to provide improved services to user m based on the taste profile.

20. A system according to claim 19 wherein:
the user profiling web application program receives the user m interaction data over a selected time period, and the program partitions [groups] the user m interaction event data into a collection of subsets of interaction events, wherein the subsets are selected so as to reflect a common context among the events within each subset.

21. A system according to claim 19 wherein:
the user profiling web application program computes, for each subset of user m interaction events, a corresponding histogram of the events according to the categorization defined in the AKB, to the extent that the items identified in the interaction events fall within at least one of the categories.

22. A system according to claim 19 wherein:
the catalog of items represented in the AKB are music items; and the interaction event data is acquired at the first web service by a music application program.

23. A system according to claim 19 wherein the first web interface is arranged to receive user interaction event data from a remote music application program executable on a mobile device rather than from a web service.

24. A user taste profile data structure comprising:
a collection of relative weights, each weight corresponding to a respective one of a predetermined set of profile factors relative to the knowledge stored in an associational knowledge base, wherein the taste profile data structure comprises one of a file, a vector, and a database table.

25. A user taste profile data structure according to claim 24 wherein the relative weights are expressed in a markup language for exchange among application programs.

26. A user taste profile data structure comprising:
a collection of relative weights, each weight corresponding to a respective one of a predetermined set of profile factors relative to the knowledge stored in an associational knowledge base; and
a collection of profile factors relative to an associational knowledge base, wherein each profile factor wherein each profile factor is a subset of the AKB categories; and
wherein the relative weights, and the corresponding profile factors, are stored together in a user taste profile data structure comprising one of a file, a vector, and a database table.

27. A user taste profile data structure according to claim 26 wherein the relative weights, and the corresponding profile factors, are stored together as associated pairs of data in a machine-readable user taste profile data structure comprising one of a file, a vector, and a database table.

28. A computer program product for generating and distributing individual user taste profiles across the internet, the computer program product comprising a computer-readable storage medium containing executable computer program code for performing a method comprising:
accessing an associational knowledge base AKB that stores relationships among a catalog of items in computer-usable form, the AKB including identification of a plurality of categories, wherein each category is a subset of the catalog of items, and the categories are selected based on similarity among the items within a category;
identifying an application, wherein the application uses the AKB to provide services to users;
acquiring from the application program and storing in memory interaction event data showing multiple users' interaction events with the items in the AKB;
analyzing the interaction data so as to define a set of profile factors for describing the users' interactions, wherein each profile factor is a subset of the AKB categories;
selecting the interaction event data for a specific individual user;
forming a taste profile of the individual user, expressed as a weighted vector of the profile factors; and
storing the individual user taste profile as a file, vector or other machine-usable data structure.

29. A computer program product according to claim 28 wherein the computer program code when executed acquires the user interaction event data from multiple application programs, each of which is driven by the AKB.

30. A computer program product according to claim 28 wherein the application program is a recommender for media items, and the items in the AKB correspond to a catalog of media items, and the user interaction events are plays of individual media items listed in the catalog.

31. A computer program product according to claim 28 wherein the computer program code when executed acquires the user interaction event data from users' mobile devices responsive to the using playing music on the device.
